(19) United States
(12) Patent Application Publication
(10) Pub. No.: US 2008/0166991 A1
(43) Pub. Date: Jul. 10, 2008

(54) Information processing apparatus, information processing method and program product

(75) Inventor: Yutaka Izumikawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/823,181

(22) Filed: Jun. 27, 2007

(30) Foreign Application Priority Data
Jan. 10, 2007 (JP) P2007-002833

(51) Int. Cl. H04M 11/04

(52) U.S. Cl. 455/404.2

(57) ABSTRACT

According to one embodiment of the invention, there is provided an information processing apparatus including: an acquisition unit configured to acquire a positional information of the information processing apparatus; a first setting unit configured to set a predetermined positional information among the positional information acquired by the acquisition unit to a first positional information indicating a present address of the information processing apparatus at a predetermined precision; a first creation unit configured to create a first mail based on a mail destination information and a transmission mail text information that are previously stored, and the low precision positional information set by the first setting unit; and a first transmitter unit configured to transmit the first mail created by the first creation unit to another information processing apparatus.

### CROSS-REFERENCE TO RELATED APPLICATIONS

The application is based on and claims the benefit of priority from the prior Japanese Patent Application No. 2007-002833, filed on Jan. 10, 2007; the entire contents of which are incorporated herein by reference.

### BACKGROUND

1. Technical Field

The present invention relates to an information processing apparatus, and more particularly to an information processing apparatus that can transmit the positional information of the present address when an urgent emergency state occurs.

2. Description of Related-Art

In recent years, the crimes such as kidnapping for child are increasing, and a portable telephone having various crime prevention functions such as a portable telephone for child, for example, has been proposed to protect the children from these crimes (refer to JP-A-20-03-249981).

With a technique disclosed in JP-A-2003-249981, the voice can be recorded associated with the position automatically and continuously without operating a recording button for specifying the voice, and the information on the voice and the position can be transmitted to a storage device at remote site, based on an instruction of the user.

However, with the related-art techniques, though the positional information of the present address can be transmitted by mail when an urgent emergency state occurs, it is presupposed that the positional information of the present address where the urgent emergency state occurs is firstly acquired by some method.

However, if the user tried to acquire some positional information based on an instruction of the user, after the urgent emergency state occurred, it took a long time to acquire the positional information, resulting in a problem that the positional information of the present address could not be transmitted by mail immediately when the urgent emergency state occurs.

As a result, the user can not immediately report to the parent or friend residing at remote site, for example, that the urgent emergency state currently occurs.

The problem can not be solved by the technique disclosed in JP-A-2003-249981.

### SUMMARY

The present invention has been made in view of the above circumstances and provides an information processing apparatus.

According to one embodiment of the invention, there is provided an information processing apparatus including: an acquisition unit configured to acquire a positional information of the information processing apparatus; a first setting unit configured to set a predetermined positional information among the positional information acquired by the acquisition unit to a first positional information indicating a present address of the information processing apparatus at a predetermined precision; a first creation unit configured to create a first mail based on a mail destination information and a transmission mail text information that are previously stored, and the low precision positional information set by the first setting unit; and a first transmitter unit configured to transmit the first mail created by the first creation unit to another information processing apparatus.

According to another aspect of the invention, there is provided an information processing method including: acquiring a positional information of the information processing apparatus; setting a predetermined positional information among the positional information to a first positional information indicating a present address of the information processing apparatus at a predetermined precision; creating a first mail based on a mail destination information and a transmission mail text information that are previously stored, and the low precision positional information, and transmitting the first mail to another information processing apparatus.

According to another aspect of the invention, there is provided a program product for enabling an information processing apparatus to perform information processing, including: an acquisition unit configured to acquire a positional information of the information processing apparatus; a first setting unit configured to set a predetermined positional information among the positional information acquired by the acquisition unit to a first positional information indicating a present address of the information processing apparatus at a predetermined precision; a first creation unit configured to create a first mail based on a mail destination information and a transmission mail text information that are previously stored, and the low precision positional information set by the first setting unit; and a first transmitter unit configured to transmit the first mail created by the first creation unit to another information processing apparatus.

### BRIEF DESCRIPTION OF THE DRAWINGS

In the accompanying drawings:

FIGS. 1A, 1B are exemplary appearance views showing an appearance configuration of a portable telephone according to an embodiment;

FIGS. 2A, 2B are exemplary appearance views showing another appearance configuration of the portable telephone;

FIGS. 3A, 3B are exemplary appearance views showing another appearance configuration of the portable telephone;

FIG. 4 is an exemplary block diagram showing the internal configuration of the portable telephone;

FIG. 5 is an exemplary flowchart for explaining a mail transmission process in the portable telephone of FIG. 1;

FIG. 6 is an exemplary view showing the contents of a preliminary mail created through a preliminary mail creation process at step S11 of FIG. 4; and

FIG. 7 is a view showing the contents of an actual mail created through an actual mail creation process at step S16 of FIG. 4.

### DESCRIPTION OF THE EMBODIMENTS

The embodiments of the present invention will be described below with reference to the drawings.

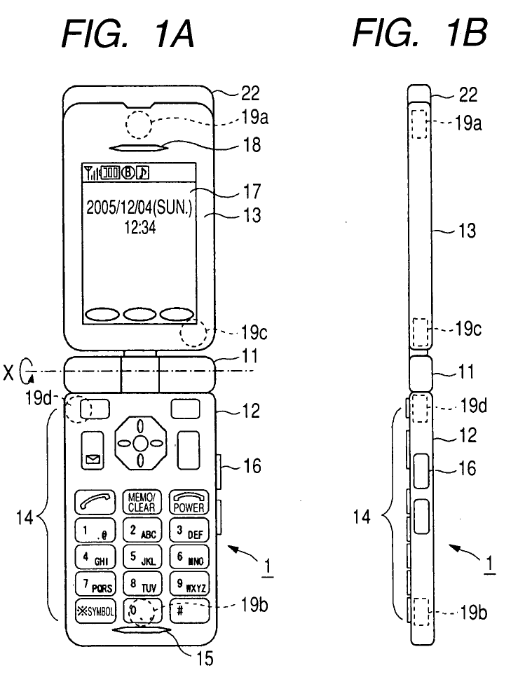

FIG. 1A shows the appearance configuration of the portable telephone 1 when opened about 180 degrees, as seen from the front face, and FIG. 1B shows the appearance configuration of the portable telephone 1 when opened, as seen from the side face.

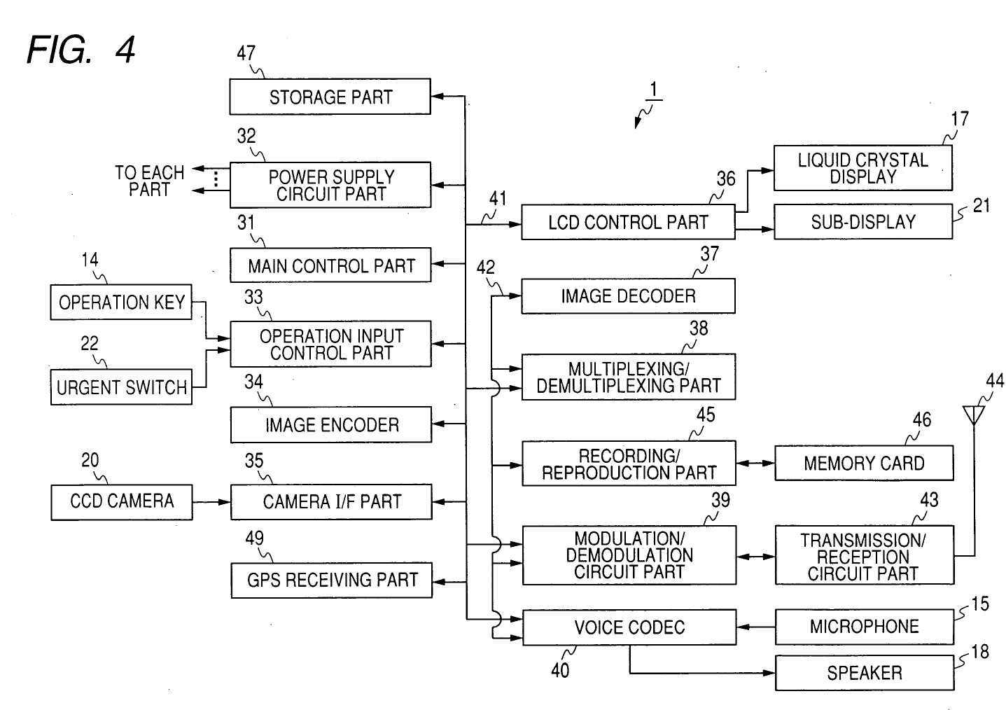

The portable telephone 1 has a first package 12 and a second package 13 hinged around a central hinge portion 11 as boundary, and formed to be foldable in a direction of the arrow X via the hinge portion 11, as shown in FIGS. 1A and 1B. A transmitting/receiving antenna (antenna 44 of FIG. 4 as will be described later) is provided at a predetermined position inside the portable telephone 1 to transmit or receive electric wave to or from a base station (not shown) via the built-in antenna.

The first package 12 is provided on its surface with the operation keys, including the numeric keys of “0” to “9”, a call out key, a redial key, a call release/power key, a clear key, and an electronic mail key, whereby various kinds of instruction can be inputted, employing the operation keys 14.

The first package 12 is provided with a cross key and a settlement key as the operation keys 14 on its top. When the user presses the cross key up, down, left or right, the cursor can be moved up, down, left or right. More specifically, it is possible to make various kinds of operation such as a scroll operation of a telephone directory list or an electronic mail displayed on a liquid crystal display 17 provided for the second package 13, a page turning operation for the simple home page and an image shift operation.

Various functions can be settled by pressing the settlement key. For example, in the first package 12, a desired telephone number is selected from among a plurality of telephone numbers in the telephone directory list displayed on the liquid crystal display 17 by the user operating the cross key, in which if the settlement key is pressed in the inner direction of the first package 12, the selected telephone number is settled and a calling process for the telephone number is performed.

The first package 12 is provided with an electronic mail key left adjacently to the cross key and the settlement key, in which if the electronic mail key is pressed in the inner direction of the first package 12, a mail transmission/reception function can be called. A browser key is provided right adjacently to the cross key and the settlement key, in which if the browser key is pressed in the inner direction of the first package 12, data of a Web page can be perused. The electronic mail key and the browser key provided left and right adjacently to the cross key and the settlement key can have various functions such as “Yes” and “No”, for example, on a screen displayed on the liquid crystal display 17, and therefore are called a soft 1 key and a soft 2 key, respectively.

The first package 12 is provided with a microphone 15 in the lower part of the operation keys 14. The voice of the user is collected by the microphone 15 during a telephone conversation. Also, the first package 12 is provided with a side key 16 for manipulating the portable telephone 1.

The first package 12 inserts a battery pack, not shown, into the back face, in which if the call release/power key is turned on, power is supplied from the battery pack to each circuit part so that the portable telephone is started up to be operable.

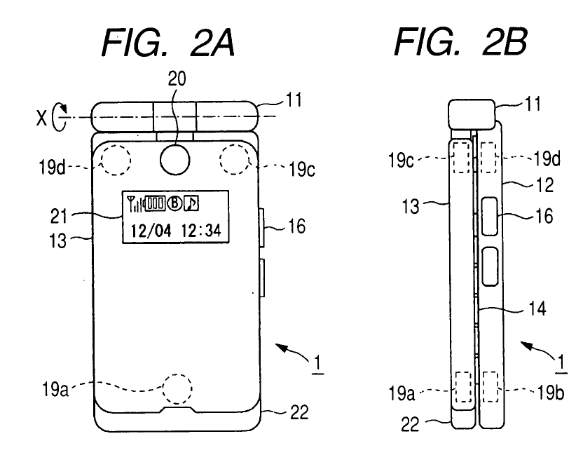

On the other hand, the second package 13 is provided with the liquid crystal display 17 (main display) on its front face. The liquid crystal display 17 can display, in addition to a receiving condition of electric wave, a remaining amount of battery, the partner names or telephone numbers registered in the telephone directory, and a transmission history, the contents of electronic mail, a simple home page, an image taken by a CCD (Charge Coupled Device) camera (CCD camera 20 of FIG. 2A as will be described later), the contents received from an external contents server (not shown), and the contents stored in a memory card (memory card 46 of FIG. 4 as will be described later).

A speaker 18 is provided at a predetermined position on top of the liquid crystal display 17, whereby the user can make a telephone conversation by voice.

FIGS. 2A, 2B show that the state of the portable telephone 1 is rotated in a direction of the arrow X from the state of the portable telephone 1 of FIG. 1. FIG. 2A shows the appearance configuration of the portable telephone 1 when closed, as seen from the front face, and FIG. 2B shows the appearance configuration of the portable telephone 1 when closed, as seen from the side face.

ACCD camera 20 is provided on the top of the second package 13, and thereby can pick up an image of a desired object of photographing. A sub-display 21 is provided in the lower part of the CCD camera 20, and displays an antenna pict indicating the current sensitivity level of the antenna, a battery pict indicating the current remaining amount of battery in the portable telephone 1, and the current time.

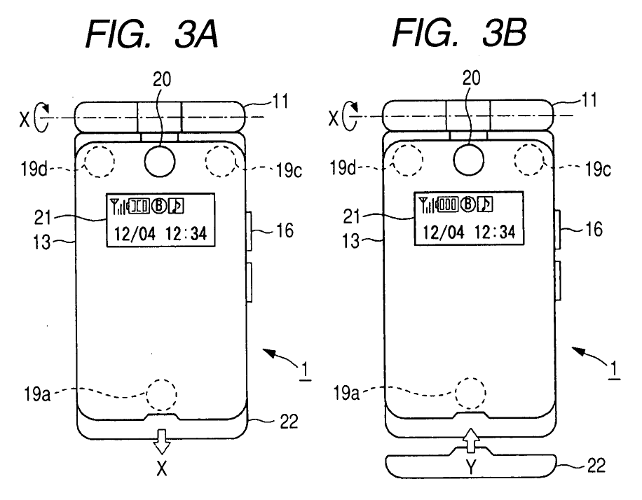

FIGS. 3A, 3B show that the state of the portable telephone 1 is rotated in a direction of the arrow X from the state of the portable telephone 1 of FIG. 1. FIGS. 3A and 3B show the appearance configuration of the portable telephone 1 when closed, as seen from the back face.

An urgent switch 22 for starting to generate a crime prevention alarm sound (i.e., burglar buzzer) (including flashing of a crime prevention alarm light with an LED (Light Emitting Diode), not shown, in a crime prevention alarm sound generation part, not shown, when an urgent emergency state occurs, is provided at a predetermined position of the first package 12 to be removable vertically, as shown in FIG. 3A.

For example, in a case where a crime prevention alarm sound is generated by the crime prevention alarm sound generation part, not shown, when an urgent emergency state occurs, the user slides and pulls down the emergency switch 22 in a direction of the arrow X, and removes the emergency switch 22, whereby it is possible that the crime prevention alarm sound is generated by the crime prevention alarm sound generation part, not shown, when the urgent emergency state occurs. The emergency switch 22 can be restored to the original position where it is attached to the second package 13 when it is slid and pulled up in a direction of the arrow Y by the user, as shown in FIG. 3B.

Besides the removable emergency switch 22, a strap-type emergency switch 22 that starts to generate a crime prevention alarm sound (i.e., burglar buzzer) in the crime prevention alarm sound generation part, not shown, by pulling out the strap may be employed.

As shown in FIG. 4, the portable telephone 1 has a main control part 31 for generally controlling each part of the first package 12 and the second package 13, to which a power supply circuit part 32, an operation input control part 33, an image encoder 34, a camera interface part 35, an LCD (Liquid Crystal Display) control part 36, a multiplexing/demultiplexing part 38, a modulation/demodulation circuit part 39, a voice codec 40, a storage part 47, and a GPS control part 49 are interconnected via a main bus 41, and to which the image encoder 34, an image decoder 37, the multiplexing/demultiplexing part 38, the modulation/demodulation circuit part 39, the voice codec 40 and a recording reproduction part 45 are interconnected via a synchronous bus 42.

The main control part 31 comprises a CPU (Central Processing Unit), a ROM (Read Only Memory), and a RAM (Random Access Memory). The CPU performs various kinds of processing in accordance with a program stored in the ROM or various kinds of application program loaded from the storage part 47 into the RAM, as well as generally controls the portable telephone 1 by generating and supplying various kinds of control signal to each part. The RAM properly stores data required for the CPU to perform various kinds of processing.

The main control part 31 includes a timer for measuring the current date and time correctly.

The portable telephone 1 converts and compresses a voice signal collected by the microphone 15 in a speech communication mode into a digital voice signal in the voice codec 40 under the control of the main control part 31, makes a spread spectrum process in the modulation/demodulation circuit part 39, and makes a digital analog conversion process and a frequency conversion process in the transmission/reception circuit part 43 to transmit the signal via the antenna 44.

The portable telephone 1 amplifies a received signal received at the antenna 44 in the speech communication mode, makes the frequency conversion process and the analog digital conversion process, makes an inverse spread spectrum process in the modulation/demodulation circuit part 39, expands the signal in the voice codec 40, converts it into an analog voice signal, and outputs the converted analog voice signal from the speaker 18.

When the portable telephone 1 transmits an electronic mail in a data communication mode, it sends out text data of the electronic mail inputted by operating the operation keys 14 via the operation input control part 33 to the main control part 31. The main control part 31 makes the spread spectrum process for the text data in the modulation/demodulation circuit part 39, and after making the digital analog conversion process and the frequency conversion process in the transmission/reception circuit part 43, transmits the signal via the antenna 44 to the base station (not shown).

On the contrary, when the portable telephone 1 receives an electronic mail in the data communication mode, it makes the inverse spread spectrum process for a received signal received from the base station (not shown) via the antenna 44 in the modulation/demodulation circuit part 39 to restore original text data, and then displays the electronic mail on the liquid crystal display 17 via the LCD control part 36.

Thereafter, the portable telephone 1 can record the received electronic mail in the memory card 46 via the recording reproduction part 45 in accordance with an operation of the user.

When the portable telephone 1 does not transmit the image signal, it directly displays the image signal taken by the CCD camera 20 via the camera interface part 35 and the LCD control part 36 on the liquid crystal display 17.

When the portable telephone 1 transmits the image signal in the data communication mode, it supplies the image signal taken by the CCD camera 20 via the camera interface part 35 to the image encoder 34.

The image encoder 34 compresses and encodes the image signal supplied from the CCD camera 20 in accordance with a predetermined encoding method such as an MPEG (Moving Picture Experts Group) 4 for conversion into an encoded image signal and sends the converted encoded image signal to the multiplexing/demultiplexing part 38. At the same time, the portable telephone 1 sends the voice collected by the microphone 15 during image pickup of the CCD camera 20 as the digital voice signal via the voice codec 40 to the multiplexing/demultiplexing part 38.

The multiplexing/demultiplexing part 38 multiplexes the encoded image signal supplied from the image encoder 34 and the voice signal supplied from the voice codec 40 in accordance with a predetermined method, makes the spread spectrum process for the resultant multiplexed signal in the modulation/demodulation circuit part 39, and after making the digital analog conversion process and the frequency conversion process in the transmission/reception circuit part 43, transmits the signal via the antenna 44.

On the contrary, the portable telephone 1 can receive data of a Web page in the data communication mode.

If the portable telephone 1 issues a request for data of a Web page, for example, in the data communication mode, the data of the Web page is transmitted via the base station (not shown) in response to the request. The data of the Web page is received via the antenna 44 by the transmission/reception circuit part 43 and the modulation/demodulation circuit part 39. The transmission/reception circuit part 43 and the modulation/demodulation circuit part 39 send out the received data of the Web page to the main control part 31.

The main control part 31 makes an interpretation of the data of the Web page, and creates a screen (image) based on the interpretation. The created screen is supplied from the main control part 31 via the LCD control part 36 to the liquid crystal display 17 and displayed thereon. That is, at least an application program of the Web browser is installed in the ROM of the main storage part 31 or the storage part 47, whereby the CPU of the main control part 31 functions as the Web browser by executing the application program of the Web browser on the RAM to interpret the data of the Web page.

When the portable telephone 1 receives data of a moving picture file linked to the Web page, for example, in the data communication mode, the modulation/demodulation circuit part 39 makes the inverse spread spectrum process for a received signal received via the antenna 44 from the base station (not shown), and sends out the resultant multiplexed signal to the multiplexing/demultiplexing part 38.

The multiplexing/demultiplexing part 38 demultiplexes the multiplexed signal into the encoded image signal and the voice signal to supply the encoded image signal via the synchronous bus 42 to the image decoder 37 and supply the voice signal to the voice codec 40. The image decoder 37 decodes the encoded image signal in accordance with a decoding method corresponding to a predetermined encoding method such as an MPEG4 to generate a reproduced moving picture signal and supply the generated reproduced moving picture signal via the LCD control part 36 to the liquid crystal display 17. Thereby, the moving picture data contained in the moving picture file linked to the Web page, for example, is displayed.

At the same time, the voice codec 40 converts the voice signal into the analog voice signal, and then supplies the analog voice signal to the speaker 18, whereby the voice signal contained in the moving picture file linked to the Web page, for example, is reproduced. In the case, the portable telephone 1 can record the received data linked to the Web page via the recording reproduction part 45 in the memory card 46 by the operation of the user, as in the case of the electronic mail.

The storage part 47 is composed of a flash memory element that is an electrically rewritable or erasable non-volatile memory, or an HDD (Hard Disc Drive), for example, and stores various application programs performed by the CPU of the main control part 31 and various kinds of data groups. Also, the storage part 47 may store the electronic mail received in accordance with the operation of the user, or the moving picture data contained in the moving picture file linked to the received Web page, as needed.

The music control part 48 controls the reproduction operation and the pause operation of audio data stored in the storage part 47, as well as a rewind function, a fast forward function, a volume down operation and a volume up operation.

The GPS receiving part 49 receives the GPS wave (GPS information) from a GPS satellite, not shown. The GPS information includes the origination time information from each GPS satellite. Thereafter, the main control part 31 computes the positional information (information of latitude and longitude) indicating the present address of the portable telephone 1 (desirably from three or four GPS information), using the acquired GPS information, whereby the positional information indicating the present address of the portable telephone 1 is obtained. As the positional information obtained based on the GPS information, the latitude and longitude are typically acquired, but the address information corresponding the latitude and longitude may be further acquired. In acquiring the latitude and longitude, or the address information corresponding the latitude and longitude, an external server (not shown) may be accessed to obtain the address information. Accordingly, the “positional information” may include the positional information (e.g., latitude and longitude information) computed from the GPS information, and the information such as address information corresponding to the computed information.

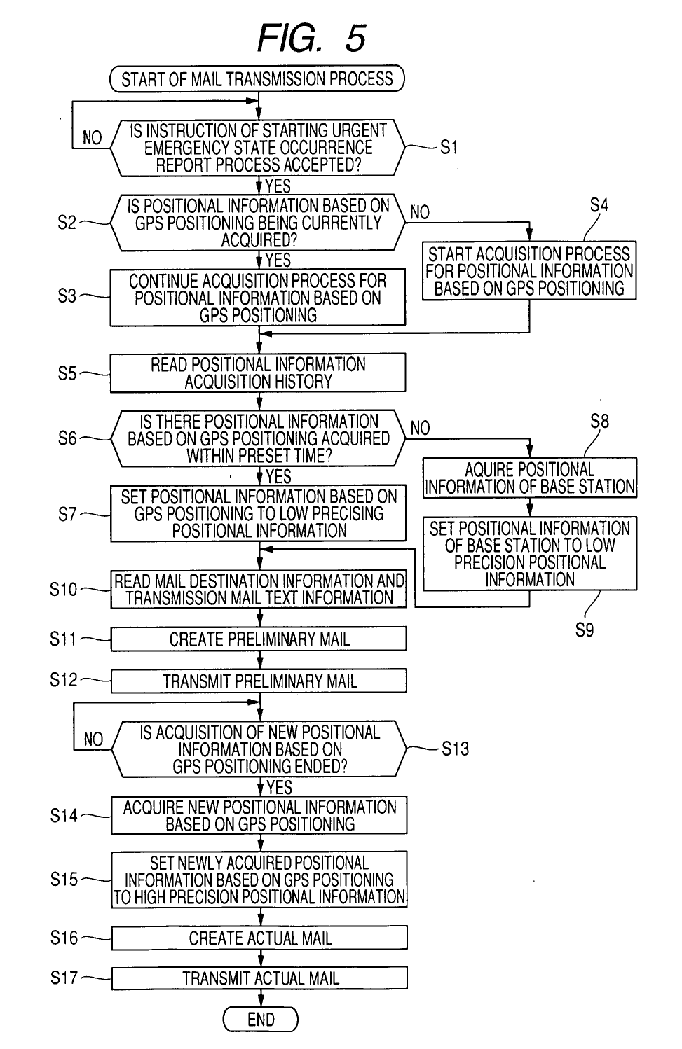

Referring to FIG. 5, a mail transmission process in the portable telephone 1 will be described below. The mail transmission process is started if an instruction of starting an urgent emergency state occurrence report process is accepted when the user makes the instruction by sliding, pulling down and removing an urgent switch 22 provided at a predetermined position of the first package 12, or by operating an operation key 14, in the event of an urgent emergency state.

At step S1, the main control part 31 determines via the operation input control part 33 whether or not an instruction of starting the urgent emergency state occurrence report process (e.g., a crime prevention alarm sound generation process with an alarm sound for crime prevention, not shown, or a crime prevention alarm light flashing process with an LED, not shown) is accepted, when the urgent switch 22 provided at the predetermined position of the first package 12 is slid by a predetermined amount, pulled down and removed by the user, or the operation key 14 is operated. The main control part 31 waits until it is determined that the instruction of starting the urgent emergency occurrence report process is accepted.

If it is determined at step S1 that the instruction of starting the urgent emergency state occurrence report process is accepted, the main control part 31 receives the GPS information (GPS wave) from a GPS satellite, not shown, and determines whether or not the positional information indicating the present address of the portable telephone 1, viz., the positional information based on the GPS positioning, is being acquired currently by using the received GPS information at step S2.

When an urgent emergency state occurs, it is determined whether or not the positional information (i.e., positional information based on the GPS positioning) indicating the present address of the portable telephone 1 is being acquired currently using the received GPS information that is already received from the GPS satellite (not shown) for another purpose (e.g., for the purpose of investigating the move destination), if the operation key 14 is operated by the user.

If it is determined at step S2 that the GPS information (GPS wave) is received from the GPS satellite, not shown, and the positional information (i.e., positional information based on the GPS positioning) indicating the present address of the portable telephone 1 is being acquired currently by using the received GPS information, the main control part 31 continues the process for acquiring the positional information based on the GPS positioning being performed currently without canceling it at step S3. Thereby, the positional information (i.e., positional information based on the GPS positioning) of the present address of the portable telephone 1 can be acquired quickly.

If it is determined at step S2 that the GPS information (GPS wave) is received from the GPS satellite, not shown, and the positional information (i.e., positional information based on the GPS positioning) indicating the present address of the portable telephone 1 is not being acquired currently by using the received GPS information, the main control part 31 activates the GPS receiving part 49 at step S4, and starts the process for acquiring the positional information based on the GPS positioning. Thereby, the process for receiving the GPS information (GPS wave) from the GPS satellite, not shown, is started, and the process for acquiring the positional information based on the GPS positioning is started.

At step S5, the main control part 31 reads a positional information acquisition history that is an acquisition history of positional information based on the GPS positioning stored in the storage part 47. Generally, if the user makes an instruction of performing the process for acquiring the positional information based on the GPS positioning for the purpose of investigating the move destination, for example, the acquired positional information based on the GPS positioning is properly registered in the positional information acquisition history stored in the storage part 47. Thereby, the positional information acquisition history is properly updated.

At step S6, the main control part 31 determines whether or not there is positional information based on the GPS positioning acquired within a preset time period (e.g., 30 minutes or less) before the current time by referring to the read positional information acquisition history.

If it is determined at step S6 that there is positional information based on the GPS positioning acquired within a preset time period (e.g., 30 minutes or less) before the current time, the main control part 31 sets the positional information based on the GPS positioning acquired within a preset time period (e.g., 30 minutes or less) before the current time, registered in the positional information acquisition history, to the low precision positional information that is positional information indicating the present address of the portable telephone 1 at low precision at step S7.

on the other hand, if it is determined at step S6 that there is not positional information based on the GPS positioning acquired within a preset time period (e.g., 30 minutes or less) before the current time, the main control part 31 acquires the base station information (positional information of the base station on Cell ID base) indicating the position of the base station from the base station, not shown, via the modulation/demodulation circuit part 39, the transmission/reception circuit part 43 and the antenna 44 at step SB.

The portable telephone 1 communicates with the base station (not shown) at an interval of 2 to 3 seconds, for example, and acquires the base station positional information indicating the position of the base station from the base station.

At step S9, the main control part 31 set the acquired base station positional information to the low precision positional information that is positional information indicating the present address of the portable telephone 1 at low precision.

At step S10, the main control part 31 reads the mail destination information that is information on the mail destination prestored in the storage part 47 and the transmission mail text information that is information on the contents of mail to be created.

The mail destination information includes the information on the transmission destination (e.g., mail address of the portable telephone 1 possessed by the parent or mail address of the personal computer) to notify that an urgent emergency state occurs in the event of the urgent emergency state. Also, the transmission mail text information includes data concerning the text data to notify that an urgent emergency state occurs in the event of the urgent emergency state.

At step S11, the main control part 31 creates a preliminary mail for notifying quickly that an urgent emergency state occurs in the event of the urgent emergency state, based on the read mail destination information and transmission mail text information, and the set low precision positional information.

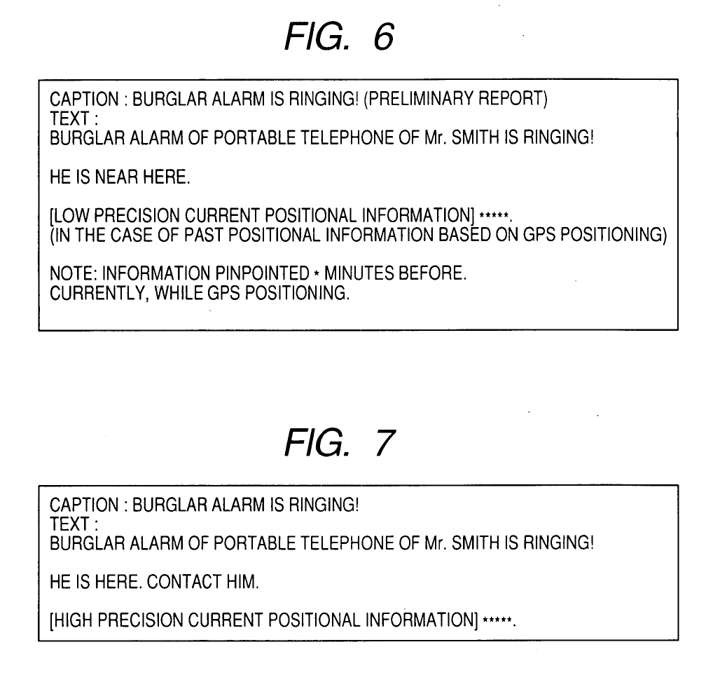

For example, a preliminary mail as shown in FIG. 6 is created. The caption is “Burglar alarm is ringing! (preliminary report)”, and the text is “Burglar alarm of portable telephone of Mr. Smith is ringing! He is near here. [Low precision current positional information]****. Currently, while GPS positioning.” That is, it is indicated that the positional information described in the preliminary mail is the low precision positional information, and the positional information based on the GPS positioning indicating the present address of the portable telephone 1 at high precision is being acquired. Thereby, if the preliminary mail is received by the other portable telephone 1 or the like, the parent, for example, can know that an urgent emergency state currently occurs for the user and the approximate present address of the user even at low precision. The positional information based on the GPS positioning indicating the present address of the portable telephone 1 may be acquired currently.

In the case where the low precision positional information is past positional information based on the GPS positioning, the preliminary mail has further a description of when the positional information based on the GPS positioning as the low precision positional information is pinpointed (acquired) as the positional information. For example, the preliminary mail has a description that “This information is pinpointed 10 minutes before”, as shown in FIG. 6.

At step S12, the main control part 31 transmits the created preliminary mail via the modulation/demodulation circuit part 39, the transmission/reception circuit part 43, the antenna 44, and the base station (not shown) to the other portable telephone 1 or predetermined personal computer.

If any urgent emergency state occurs for the user, the positional information on the approximate present address of the user even at low precision can be informed quickly to the parent, for example. More specifically, if the user tried to acquire the GPS information indicating the present address at high precision after the urgent emergency state occurred, it usually took a time of about 30 seconds, for example, to transmit a mail for reporting that the urgent emergency state occurred. On the contrary, the preliminary mail including the positional information on the approximate present address of the user even at low precision can be transmitted quickly in a time of about 10 seconds.

At step S13, the main control part 31 determines whether or not the acquisition process for positional information based on the GPS positioning is ended, and waits until it is determined that the acquisition process for positional information based on the GPS positioning is ended.

If it is determined at step S13 that the acquisition process for positional information based on the GPS positioning is ended, the main control part 31 receives the GPS information (GPS wave) from the GPS satellite, not shown, and newly acquires the positional information (i.e., positional information based on the GPS positioning) indicating the present address of the portable telephone 1 by using the received GPS information at step S14.

At step S15, the main control part 31 sets the newly acquired positional information based on the GPS positioning to the high precision positional information that is positional information indicating the present address at high precision.

At step S16, the main control part 31 creates an actual mail for notifying correct the place where an urgent emergency state occurs in the event of the urgent emergency state based on the read mail destination information and transmission mail text information, and the set high precision positional information.

For example, an actual mail is created as shown in FIG. 7. The caption is “Burglar alarm is ringing!”, and the text is “Burglar alarm of portable telephone of Mr. Smith is ringing!He is here. Contact him (her). [High precision current positional information] ****”. That is, it is indicated that the user currently resides just at the place indicated by the positional information as described in the actual mail and the urgent emergency state occurs at that place. Thereby, if the actual mail is received by the other portable telephone 1 or the like, the parent, for example, can know that the user currently resides just at the place indicated by the positional information as described in the actual mail and the urgent emergency state occurs at the place.

At step S17, the main control part 31 transmits the created actual mail via the modulation/demodulation circuit part 39, the transmission/reception circuit part 43, the antenna 44, and the base station (not shown) to the other portable telephone 1 or predetermined personal computer.

According to the embodiment, if an instruction of starting the urgent emergency state occurrence report process is accepted when the user makes the instruction in the event of the urgent emergency state, it is determined whether or not there is positional information based on the GPS positioning acquired within a preset time period (e.g., 30 minutes or less) before the current time by referring to the positional information acquisition history. If it is determined that there is positional information based on the GPS positioning acquired within a preset time period (e.g., 30 minutes or less) before the current time, the positional information based on the GPS positioning acquired within a preset time period (e.g., 30 minutes or less) before the current time is set to the low precision position information indicating the present address of the portable telephone 1 at low precision, or if it is determined that there is not positional information based on the GPS positioning acquired within a preset time period (e.g., 30 minutes or less) before the current time, the base station positional information indicating the position of the base station is set to the low precision position information indicating the present address of the portable telephone 1 at low precision.

Thereafter, a preliminary mail for notifying quickly that the urgent emergency state occurs in the event of the urgent emergency state can be created, ahead of the actual mail for notifying correctly the place where the urgent emergency state occurs in the event of the urgent emergency state, based on the mail destination information and transmission mail text information that are prestored in the storage part 47, and the low precision positional information, and the created preliminary mail can be transmitted to the other portable telephone 1 or the personal computer.

If an instruction of starting the urgent emergency state occurrence report process is accepted when the user makes the instruction in the event of the urgent emergency state, it is determined whether or not the GPS information (GPS wave) is currently received from the GPS satellite, not shown, and the positional information (i.e., positional information based on the GPS positioning) indicating the present address of the portable telephone 1 is being acquired currently by using the received GPS information. If it is determined that the GPS information (GPS wave) is received from the GPS satellite, not shown, and the positional information (i.e., positional information based on the GPS positioning) indicating the present address of the portable telephone 1 is being acquired currently by using the received GPS information, the acquisition process for positional information based on the GPS positioning is not canceled but continued, or if it is determined that the GPS information (GPS wave) is received from the GPS satellite, not shown, and the positional information (i.e., positional information based on the GPS positioning) indicating the present address of the portable telephone 1 is not being acquired currently by using the received GPS information, the GPS receiving part is activated and the acquisition process for positional information based on the GPS positioning is started.

If it is determined that the acquisition process for positional information based on the GPS positioning is ended, the newly acquired positional information based on the GPS positioning is set to the high precision positional information indicating the present address of the portable telephone 1 at high precision, and an actual mail for notifying correctly the place where the urgent emergency state occurs in the event of the urgent emergency state, based on the mail destination information and transmission mail text information that are prestored in the storage part 47, and the positional information, whereby the created actual mail can be transmitted to the other portable telephone 1 or the personal computer.

If any urgent emergency state occurs for the user, the approximate present address of the user even at low precision can be informed quickly to the parent, for example, and thereafter the correct present address of the user can be informed later. As a result, the parent, for example, can know quickly (almost in real time) that some urgent emergency state occurs for the user. Accordingly, the convenience in the event of urgent emergency state can be improved.

The positional information based on the GPS positioning or the base station positional information is defined as the “positional information” indicating the present address of the portable telephone 1.

According to the above-described embodiment, it is possible to improve the convenience when the urgent emergency state occurs.

The embodiment may be applied to a PDA (Personal Digital Assistant), a personal computer, a handy game machine, a portable music sound-reproducing system, a portable animation reproducing system, and other information processing apparatuses, in addition to the portable telephone 1.

A series of processes as described in the embodiment may be performed by software or hardware.

Though in the embodiment, the steps of the flowchart are performed in time series according to the prescribed sequence, those steps are not necessarily performed in time series, but may be performed in parallel or individually.

What is claimed is:

1. An information processing apparatus comprising:
an acquisition unit configured to acquire a positional information of the information processing apparatus;
a first setting unit configured to set a predetermined positional information among the positional information acquired by the acquisition unit to a first positional information indicating a present address of the information processing apparatus at a predetermined precision;
a first creation unit configured to create a first mail based on a mail destination information and a transmission mail text information that are previously stored, and the low precision positional information set by the first setting unit; and
a first transmitter unit configured to transmit the first mail created by the first creation unit to another information processing apparatus.

2. The information processing apparatus according to claim 1, comprising:
a determination unit configured to determine whether or not there is a GPS-based second positional information of the information apparatus acquired within a predetermined time preset by the acquisition unit,
wherein, if the determination unit determines that there is the GPS-based second positional information, the first setting unit sets the GPS-based second positional information to the first positional information, and
wherein, if the determination unit determines that there is not the GPS-based second positional information, the first setting unit sets a base station positional information indicating the position of a base station to the first positional information.

3. The information processing apparatus according to claim 1, comprising:
a second setting unit configured to set a GPS-based third positional information acquired by the acquisition unit to a GPS-based fourth positional information of the information processing apparatus indicating the present address of the information processing apparatus at a higher precision than the predetermined precision, after accepting an instruction of starting an urgent emergency state occurrence report process,
a second creation unit configured to create a second mail based on the mail destination information and the transmission mail text information that are previously stored, and the GPS-based fourth positional information of the information processing apparatus set by the second setting unit, and
a second transmitter unit configured to transmit the second mail created by the second creation unit to another information processing apparatus.

4. The information processing apparatus according to claim 1, comprising:
a determination unit configured to determine whether or not a GPS-based fifth positional information is being acquired by the acquisition unit, when an instruction of starting the urgent emergency state occurrence report process is accepted, and
a control unit configured to start an GPS-based acquisition process for the positional information if the GPS-based fifth positional information is not being acquired when the instruction of starting the urgent emergency state occurrence report process is accepted, and continue the GPS-based acquisition process for the GPS-based fifth positional information if the GPS-based fifth positional information is being acquired when the instruction of starting the urgent emergency state occurrence report process is accepted.

5. The information processing apparatus according to claim 1, wherein the predetermined precision is a precise degree of the predetermined positional information with respect to the present address of the information processing apparatus.

6. An information processing method comprising:
acquiring a positional information of the information processing apparatus;
setting a predetermined positional information among the positional information to a first positional information indicating a present address of the information processing apparatus at a predetermined precision;
creating a first mail based on a mail destination information and a transmission mail text information that are previously stored, and the low precision positional information; and
transmitting the first mail to another information processing apparatus.

7. The information processing apparatus method according to claim 6, comprising:
determining whether or not there is a GPS-based second positional information of the information apparatus acquired within a predetermined time preset;
setting the GPS-based second positional information to the first positional information, if it is determined that there is the GPS-based second positional information, and
setting a base station positional information indicating the position of a base station to the first positional information, if it is determined that there is not the GPS-based second positional information.

8. The information processing method according to claim 6, comprising:
setting a GPS-based third positional information to a GPS-based fourth positional information of the information processing apparatus indicating the present address of the information processing apparatus at a higher precision than the predetermined precision, after accepting an instruction of starting an urgent emergency state occurrence report process;
creating a second mail based on the mail destination information and the transmission mail text information that are previously stored, and the GPS-based fourth positional information of the information processing apparatus, and
transmitting the second mail to another information processing apparatus.

9. The information processing method according to claim 6, comprising:
determining whether or not a GPS-based fifth positional information is being acquired, when an instruction of starting the urgent emergency state occurrence report process is accepted;
starting an GPS-based acquisition process for the positional information if the GPS-based fifth positional information is not being acquired when the instruction of starting the urgent emergency state occurrence report process is accepted, and
continue the GPS-based acquisition process for the GPS-based fifth positional information if the GPS-based fifth positional information is being acquired when the instruction of starting the urgent emergency state occurrence report process is accepted.

10. A program product for enabling an information processing apparatus to perform information processing, comprising:
an acquisition unit configured to acquire a positional information of the information processing apparatus;
a first setting unit configured to set a predetermined positional information among the positional information acquired by the acquisition unit to a first positional information indicating a present address of the information processing apparatus at a predetermined precision;
a first creation unit configured to create a first mail based on a mail destination information and a transmission mail text information that are previously stored, and the low precision positional information set by the first setting unit; and
a first transmitter unit configured to transmit the first mail created by the first creation unit to another information processing apparatus.

11. The program product according to claim 10, comprising:
a determination unit configured to determine whether or not there is a GPS-based second positional information of the information apparatus acquired within a predetermined time preset by the acquisition unit,
wherein, if the determination unit determines that there is the GPS-based second positional information, the first setting unit sets the GPS-based second positional information to the first positional information, and
wherein, if the determination unit determines that there is not the GPS-based second positional information, the first setting unit sets a base station positional information indicating the position of a base station to the first positional information.

12. The program product according to claim 10, comprising:
a second setting unit configured to set a GPS-based third positional information acquired by the acquisition unit to a GPS-based fourth positional information of the information processing apparatus indicating the present address of the information processing apparatus at a higher precision than the predetermined precision, after accepting an instruction of starting an urgent emergency state occurrence report process,
a second creation unit configured to create a second mail based on the mail destination information and the transmission mail text information that are previously stored, and the GPS-based fourth positional information of the information processing apparatus set by the second setting unit, and
a second transmitter unit configured to transmit the second mail created by the second creation unit to another information processing apparatus.

13. The program product according to claim 10, comprising:
a determination unit configured to determine whether or not a GPS-based fifth positional information is being acquired by the acquisition unit, when an instruction of starting the urgent emergency state occurrence report process is accepted, and
a control unit configured to start an GPS-based acquisition process for the positional information if the GPS-based fifth positional information is not being acquired when the instruction of starting the urgent emergency state occurrence report process is accepted, and continue the GPS-based acquisition process for the GPS-based fifth positional information if the GPS-based fifth positional information is being acquired when the instruction of starting the urgent emergency state occurrence report process is accepted.

14. The program product according to claim 10, wherein the predetermined precision is a precise degree of the predetermined positional information with respect to the present address of the information processing apparatus.
